(19) United States
(12) Patent Application Publication
(10) Pub. No.: US 2007/0252386 A1
(43) Pub. Date: Nov. 1, 2007

(54) PRESSURE TANK FITTING ASSEMBLY

(76) Inventors: Ronald J. Cress, Indianapolis, IN (US); Rick D. Pelfrey, Indianapolis, IN (US); Jeffrey M. Carter, Anderson, IN (US)

Correspondence Address: BOSE MCKINNEY & EVANS LLP;JAMES COLES, 135 N PENNSYLVANIA ST, SUITE 2700, INDIANAPOLIS, IN, 46204, US

(21) Appl. No.: 11/533,906

(22) Filed: Sep. 21, 2006

Related U.S. Application Data
(60) Provisional application No. 60/719,364, filed on Sep. 22, 2005.
(60) Provisional application No. 60/785,103, filed on Mar. 23, 2006.

(51) Int. Cl. F16L 41/00

(52) U.S. Cl. 285/209

(57) ABSTRACT

A fitting assembly for use with a component, such as a tank containing a fluid. The fitting assembly can be used with a pressurized tank coupled to a pressurized fluid system, including pressurized air. The fitting assembly includes a spud and a corresponding fitting wherein the spud or fitting include pins which cooperate with a corresponding groove or slot of the related spud or fitting.

### CROSS-REFERENCE TO RELATED APPLICATIONS

This application claims the benefit of U.S. Provisional Patent Application Ser. No. 60/719,364, titled “Pressure Tank Fitting Assembly”, to Cress et al., filed Sep. 22, 2005 and U.S. Provisional Patent Application Ser. No. 60/785,103, titled “Pressure Tank Fitting Assembly” to Cress et al., filed Mar. 23, 2006, the disclosures of which are expressly incorporated by reference herein in their entirety.

### FIELD OF THE INVENTION

The present invention relates to a fitting assembly which can be used with a component body, including a valve body, a cylinder body or a tank containing a fluid. More particularly, the fitting assembly can be used with a pressurized tank coupled to a pressurized fluid system, including an air brake system for vehicles having air brakes.

### BACKGROUND AND SUMMARY OF THE INVENTION

Fitting assemblies are used to connect tanks to either mechanical or electro-mechanical systems requiring a fluid for operation. A fluid is typically defined as either a gas or a liquid or other material which flows. Known fitting assemblies can include a spud type device welded to a tank. The spud has a threaded machined port which can be coupled to a fitting having a mating threaded connection. The fitting can be coupled to a line or hose which connects the tank to the mechanical and/or electro-mechanical systems. It is also known to use bayonet mount or bayonet connectors as electrical cable connectors.

In one exemplary embodiment, fitting assemblies are typically used with air pressure tanks located on heavy or large vehicles which use air brakes. The fitting assemblies connect an air pressure tank, located on the vehicle, to a brake system, an air compressor, or other pressure tanks located within the air brake system. The brake system, air compressor, and other pressure tanks are typically coupled through a first air pressure tank which includes the fitting assemblies. Typically a fitting assembly is connected to the pressure tank by utilizing a machined steel spud which is welded to the pressure tank. The spud includes a threaded port machined into one end of the spud to allow a corresponding fitting to be threaded into place. While conventional threaded connections provide for the connection of the pressurized tanks to other systems, such fittings having threaded connections require the use of fitting compounds or fitting tape to insure a substantially leak proof connection between the spud and fitting. Such connections over time can, however, develop leaks which require maintenance. In addition threads can become frozen thereby increasing repair time.

The present invention eliminates the threaded connections on the spud and fitting. During manufacturing of the pressure tank, the spud portion of the present invention is welded into place by a welding process, including an induction welding process. The spud portion may also be machined as part of a component body to which it is attached. In addition, the fitting portion of the assembly is manufactured with grooves that allow pins in the spud to travel within the grooves and to lock in place. A spring located internally of the assembly is used to assist in locking the fitting assembly in place and to prevent inadvertent disconnection. An o-ring is used to form a seal between the spud and fitting.

In accordance with one aspect of the present invention, there is provided a fitting assembly for use with a tank containing a fluid. The fitting assembly includes a spud, including spud body having a cavity wherein the spud body includes a protrusion extending into the cavity. The fitting assembly also includes a fitting, including a fitting body having a portion configured to fit within the cavity of the spud body wherein the fitting includes a groove, to receive the protrusion.

In accordance with another aspect of the present invention, there is provided a fitting assembly for use with a tank containing a fluid. The fitting assembly includes a first body having a cavity wherein the first body includes one of a protrusion and a groove. The fitting assembly also includes a second body, including a portion configured to fit within the cavity of the first body. The second body includes the other of the one of the protrusion and the groove of the first body, wherein the protrusion and the groove cooperate to hold the first body to the second body in a fixed position.

Pursuant to another aspect of the present invention, there is provided a pressurizable tank system for holding a pressurized fluid. The tank system includes a tank, defining an interior, an exterior, an aperture and a fitting assembly. The fitting assembly includes a spud body coupled to the aperture wherein the spud body has a cavity and a protrusion extending into the cavity. The fitting assembly also includes a fitting body having a portion configured to fit within the cavity of the spud body, the fitting body including a groove, to receive the protrusion.

Pursuant to an additional aspect of the present invention, there is provided a pressurizable system for holding a pressurized fluid comprising a component, defining an interior, an exterior, and an aperture. The pressurizable system includes a fitting assembly having a first body coupled to the aperture, the first body having a cavity and one of a protrusion and a groove, and a second body having a portion configured to fit within the cavity of the first body. The second body includes the other of the one of a protrusion and a groove of the first body, wherein the protrusion and the groove cooperate to hold the first body to the second body in a fixed position.

### BRIEF DESCRIPTION OF THE DRAWINGS

A detailed description particularly refers to the accompany figures in which:

FIG. 1 illustrates a schematic view of an air brake system used in a vehicle having air brakes including an air pressurized tank and a fitting assembly of the present invention.

FIG. 2 illustrates a perspective view of one embodiment of the present invention including a spud and a fitting attached thereto.

FIG. 3 illustrates an exploded view of the fitting assembly of FIG. 2.

FIG. 4 is a cross-sectional view of the fitting assembly along a line 4-4 of FIG. 2.

FIG. 5 is a perspective view of another embodiment of the present invention including a spud and a fitting for connecting to an elbow connector.

FIG. 6 illustrates an exploded perspective view of the fitting assembly of FIG. 5.

FIG. 7 illustrates a cross-sectional view of the fitting assembly of FIG. 5 along a line 7-7.

FIG. 8 illustrates a side view of the fitting assembly of FIG. 6.

FIG. 9 illustrates another embodiment of the present invention of the fitting assembly coupled to an elbow connector.

FIG. 10 illustrates an exploded perspective view of the fitting assembly including the elbow connector of FIG. 9.

FIG. 11 is a perspective exploded view of another embodiment of the present invention including a spud and a fitting having a cap.

FIG. 12 illustrates a cross-sectional view of the fitting assembly of FIG. 11 along a line 12-12.

FIG. 13 illustrates a bottom perspective view of the fitting assembly of FIG. 11.

Additional features of the invention will become apparent to those skilled in the art upon consideration of the following detailed description and drawings.

### DETAILED DESCRIPTION OF THE DRAWINGS

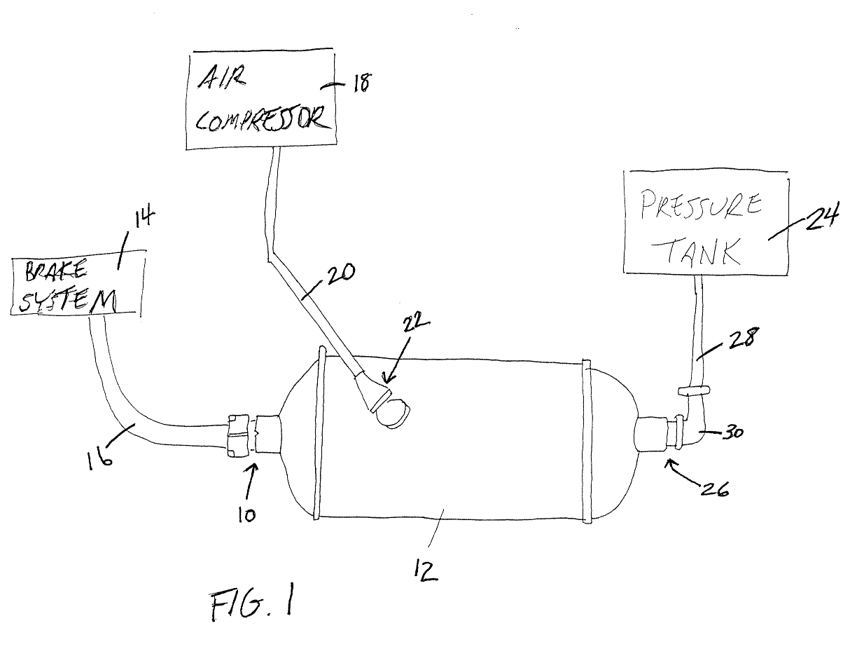

According to the present disclosure, a fitting assembly 10 is provided for use with a component body, such as a fluid tank 12. As illustrated, the fluid tank 12 is provided for use in an air brake system of a heavy vehicle (not shown). As shown in FIG. 1, the fluid tank 12 is coupled to a brake system 14 through a hose or tube 16 and through the fitting assembly 10 which is connected to the tank 12. The fluid tank 12 is also coupled to an air compressor system 18 which provides compressed air for filling the fluid tank 12 through a hose 20 coupled to the tank with a fitting assembly 22. In addition, the fluid tank 12 may also be coupled to one or more pressure tanks 24, or reservoirs, to provide additional braking power for the vehicle. The pressure tank 24 is connected to the fluid tank 12 through a third fitting assembly 26 which is coupled to the tank 24 through a hose or line 28. The fitting assembly 26 is also connected to an elbow 30 which provides the appropriate change in direction so that the tank 12 can be effectively coupled to the pressure tank 24. The present invention, includes one or more embodiments of the fitting assemblies 10, 22, and 26 to be described later herein.

The fluid tank 12 is typically coupled to a frame (not shown) of the heavy vehicle. While such heavy vehicles can require pressurized air to control and power air brakes, additional systems may also be operated by pressurized air and include power steering systems (not shown), leveling systems (not shown), and other air driven systems of the vehicle. While the present invention is described with respect to the air braking system of a vehicle, the present invention is not limited to this particular application. For instance, the fitting assembly of the present invention may be coupled to tanks which are not pressurized or other pressurized tanks which deliver pressurized liquids. Likewise, the present invention need not be limited to a vehicle application or to a tank application. The present invention may also be used with other fluid components or connectors, including valve bodies, air dryer bodies, cylinder bodies, and in pneumatic systems used for operating pneumatically controlled devices. Such systems can include air drivers or other air operated tools including those found in workshops or factory settings.

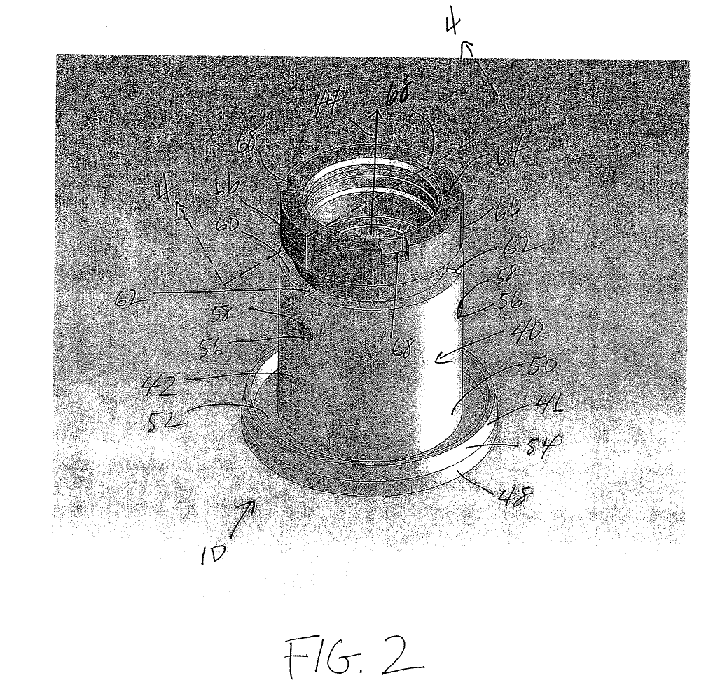

FIG. 2 illustrates one embodiment of the fitting assembly 10 of the present invention. The fitting assembly 10 includes a spud 40 including a spud body, such as a cylinder 42, having a longitudinal axis 44. The cylinder 42 is coupled to a flange 46 which extends in a direction substantially perpendicular to the longitudinal axis 44 of the cylinder 42. The flange 46 can be coupled to the cylinder 42 by a variety of methods including welding, adhesives, or can be formed as a single part with the cylinder. The flange 46 includes a rim 48 which extends from a base portion 50 of the cylinder 42. The rim 48 includes a planar surface 52 which extends laterally from the base portion 50 and includes an outer dimension which is circular in configuration. Extending in a direction substantially perpendicular to the planar surface 52, is an upstanding ridge 54 located about the circumference of the rim 48. The upstanding ridge 54 may be formed as a part of the rim or it may be a separate piece which can be welded or adhered to the rim 48 as would be known by those skilled in the art.

The cylinder 42 includes one or more apertures 56 which receive one or more pins or protrusions 58 which extend into the interior cavity of the cylinder 42. A top portion 60 of the cylinder 42 includes a plurality of notches or grooves 62 which provide an indexing mechanism for locating a fitting 64 within an interior cavity of the cylinder 42.

The spud and fitting can be made from a variety of materials including those having sufficient rigidity and a yield strength selected for the particular application. Such materials include metals, such as steel, brass and aluminum, and plastics, such as polyamides, including nylon, and polybutylene terephtalate (PBT).

When the fitting 64 is aligned in a locked position with the spud 40, one or more notches or grooves 66 formed into an outer surface of the fitting 64 are aligned with the notches 62 of the cylinder 42. In addition, the fitting 64 includes one or more cut outs or apertures 68 which accept an insertion/removal tool having corresponding portions to engage and to move the fitting 64 to a locked position with the spud 40, to be described later herein.

During manufacturing of the tank 12 of FIG. 1, the flange 46 of the spud 40 is welded to the tank by a welding process, including an induction welding process. The pressure tank includes a hole through which the cylinder 42 is inserted until the upstanding ridge 54 is in contact with an interior wall of the tank 12. Induction welding is applied to the corresponding assembly and is used to isolate as much heat as possible to prevent warpage of an o-ring seal which is included within the assembly and which is described later herein. After the spud 40 is welded into place, the fitting 64 can be placed into the spud. The grooves 68 of the fitting are lined up with the pins 56 of the spud 40. By applying pressure and a clock-wise turn of the tool, the fitting can be positioned at a location to lock the fitting into place. By removing the tool, a spring, to be described later, forces the fitting into a locked position. To insure that the fitting 64 is in a proper and locked position, indicators 62 are aligned with indicators 66. To remove the fitting 64 from the spud 40, pressure is released from the tank and the tool is positioned into the grooves 68. Applying pressure and turning the tool in a counter-clock-wise direction provides for removal of the fitting 64 from the spud 40. While the indicators are illustrated as being formed as notches or groove, other types of indicators are possible, including circular and triangular indicators.

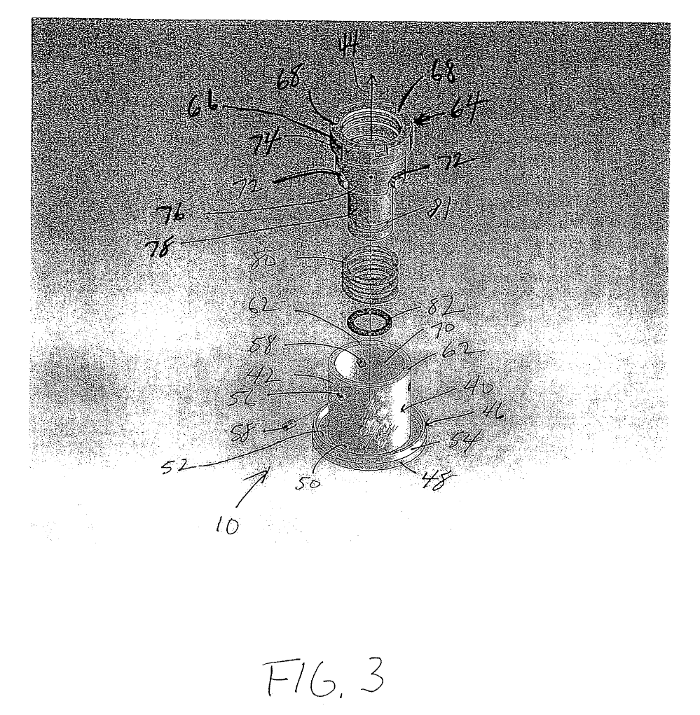

FIG. 3 illustrates a perspective exploded schematic view of the fitting assembly 10 of FIG. 1. As previously described, the spud 40 includes a neck or cylinder 42 coupled to the flange 46. The cylinder 42 defines an internal cavity 70 into which the pins 58 extend. While the pins 58 are shown as being individual elements inserted into the apertures 56, the pins 58 need not be a separate element but can be formed as a single piece with the cylinder 42.

As previously described with respect to FIG. 2, the fitting 64 is inserted into the cavity 70 of the spud 40. The fitting 64 is held in place by the pins 58 which cooperate with corresponding grooves 72 formed into the body of the fitting 64. The fitting 64 includes a generally cylindrically shaped body which is inserted into the cavity 70. The fitting 64 includes a first portion 74 having the indexes 66 and the grooves 68 formed therein. The first portion 74 includes an outer diameter which can be substantially the same as the outer diameter of the spud 40. A second portion 76 of the fitting 64 includes the grooves 72 formed therein. The second portion 76 includes an outer diameter less than the inner diameter of the cavity 70 to enable insertion of the second portion 76 into cavity 70. When the fitting 64 is inserted into the cavity 70, the pins 58 engage the grooves 72 and are disposed therein for connection of the fitting 64 to the spud 40.

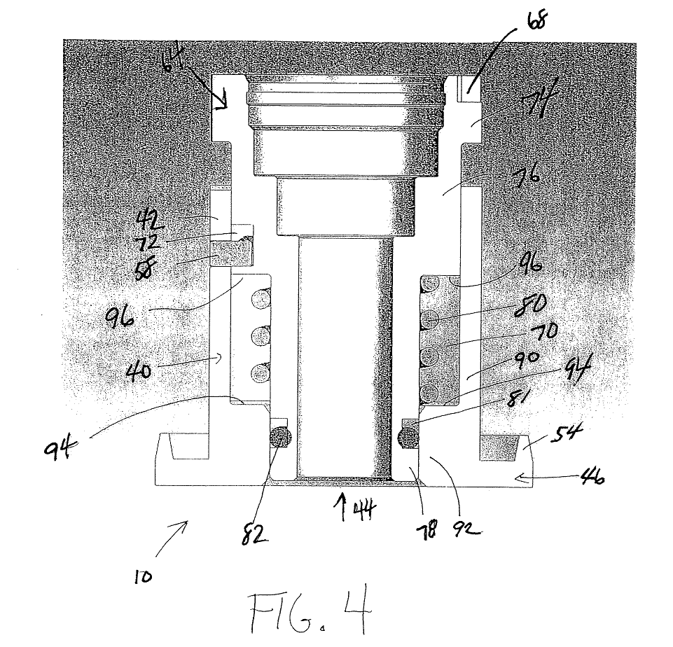

A third portion 78 of the fitting 64 includes an outer diameter which is less than the outer diameter of the second portion 76. The outer diameter of the third portion 78 enables the third portion 78 to be inserted through a spring 80. The spring 80 supplies a spring force to enable the fitting 64 to be locked in place when the pins 58 are appropriately positioned within the grooves 72. The third portion 78 also includes a channel 81 into which an o-ring seal 82 is located. The o-ring seal 82 provides for a fluidic seal between the fitting 64 and the spud 40. The interior of the cavity 70 is defined such that the o-ring 82 contacts the interior of the cavity 70 shown in more detail in FIG. 4.

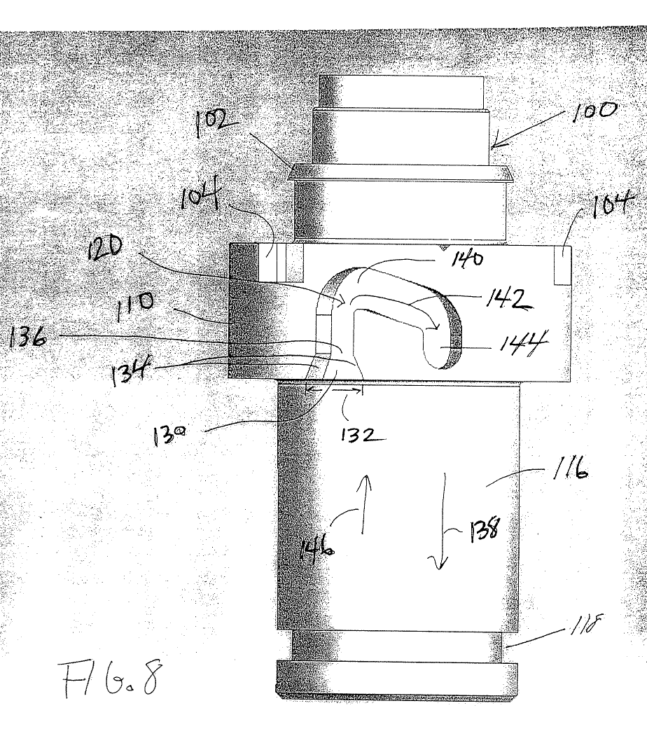

FIG. 4 illustrates a schematic cross-sectional view of the fitting assembly 10 of FIG. 2 along the lines 4-4. As illustrated in FIG. 4, the fitting 64 is inserted into the spud 40 and held in place by the pin 58 engaging the grooves 72. The configuration of the grooves 72 will be described in more detail with respect to FIG. 8. The cavity 70 of the spud 40 is defined by a first portion 90 and a second portion 92. The first portion 90 includes an inner diameter which is slightly larger than the outer diameter of the second portion 76 of the fitting 64 to enable the fitting 64 to fit within the spud 40. The second portion 92 includes an inner diameter which is slightly larger than the outer diameter of the third portion 78 of the fitting 64. As can be seen, the o-ring 82, which is disposed within the channel 81 contacts the second portion 92 to form a seal therewith.

The interior cavity 70 is also defined by a step or shoulder 94 which is located at a transition between the first portion 90 and the second portion 92. While the step or shoulder 94 is illustrated as being substantially perpendicular to the axial direction 44, other configurations are possible so long as the step or shoulder 94 provides a butting surface to engage the spring 80 during insertion of the fitting 64 into the spud 40. An opposite end of the spring 80 abuts a shoulder or step 96 which is formed at the intersection of the second portion 76 and the third portion 78 of the fitting 64. Consequently, during insertion of the fitting 64 into the spud 40, the spring provides a resilient counteracting force to enable the locking of the fitting to the spud. FIG. 4 also illustrates the cavity of the fitting 64 which is defined by interior sidewalls of the fitting. This particular cavity as illustrated is defined to engage an available off the shelf part for attaching the fitting 64 to a hose as is known by those skilled in the art.

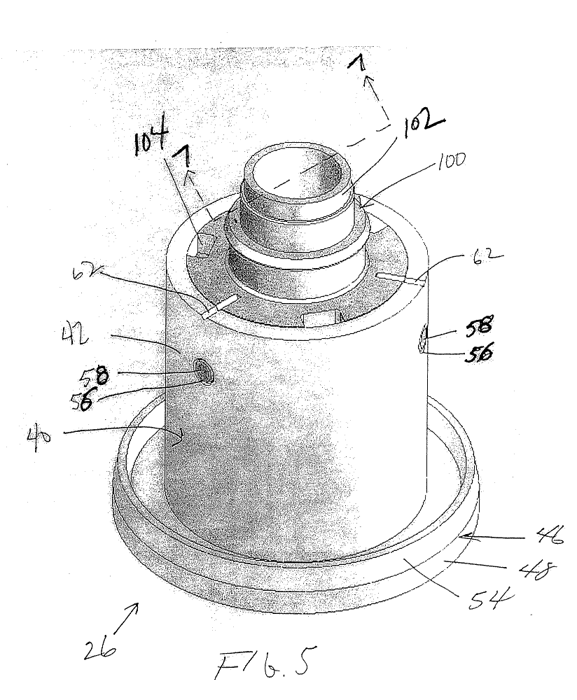

FIG. 5 illustrates another embodiment of a fitting assembly, for instance fitting assembly 26 of FIG. 1. In this embodiment, the spud 40 can be as previously described. A fitting 100 is provided for connection to the elbow 30 as illustrated in FIG. 1. The elbow 30 attaches to an extended portion 102 which is made part of the fitting 100. As previously described, the fitting includes grooves 104 which receive a tool for insertion and removal.

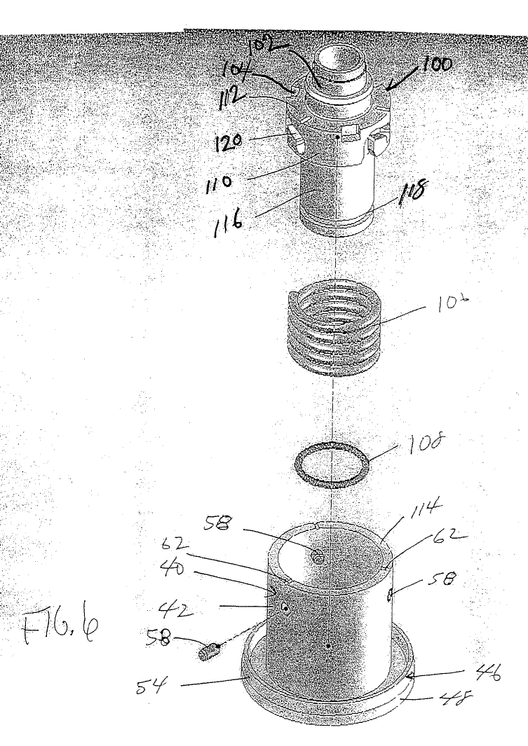

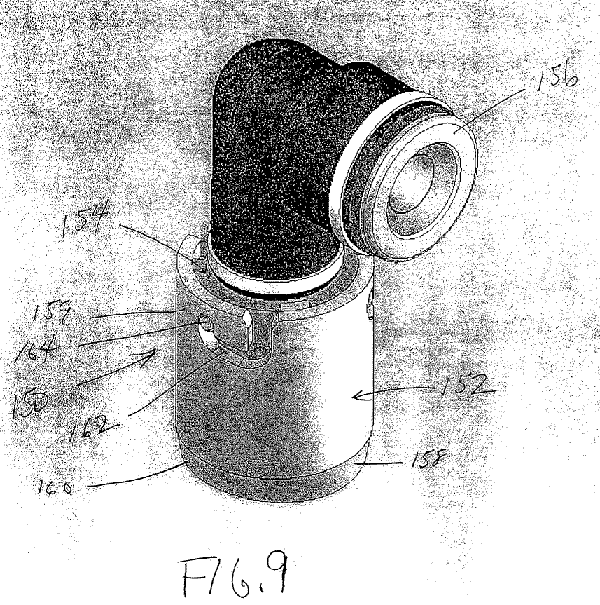

As illustrated in FIG. 6, the fitting assembly 26 includes a spring 106 and an o-ring 108 which functions as previously described. The fitting 100 includes a first portion 110 which has an outer diameter slightly less than the inner diameter of the cylinder 42. When the fitting 100 is fully inserted into the spud 40, a top surface 112 is substantially flush with a top surface 114 of the cylinder 42 which can also be seen in FIG. 5. The fitting assembly 100 also includes a second portion 116. A channel 118 receives the o-ring 108 which forms a seal with the second portion 92 of the cylinder 42 (see FIG. 9). As before, the fitting 100 also includes a plurality of grooves 120 which receive the pins 56 of the spud 40. The upwardly extending portion 102 can receive an elbow fitting as understood by those skilled in the art.

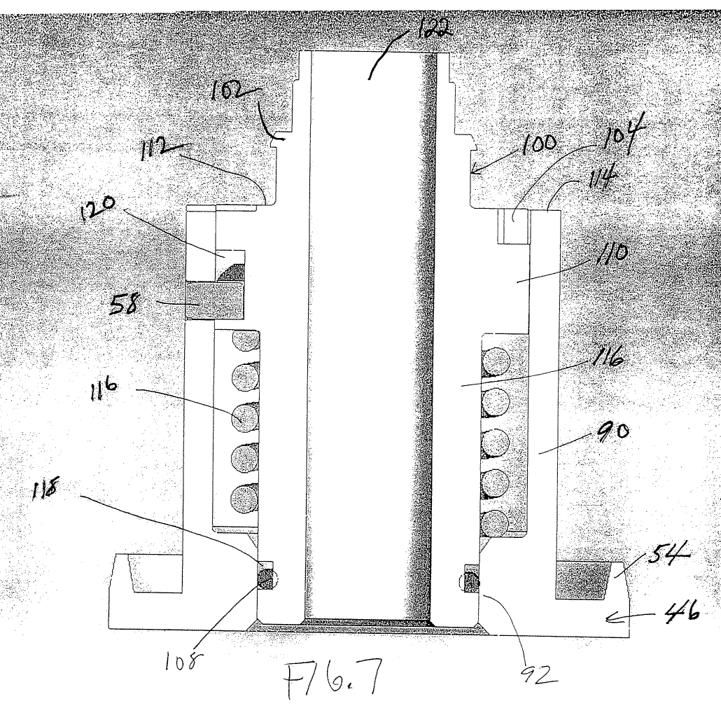

The fitting assembly 26 is further illustrated in FIG. 7 as a schematic cross-sectional view taken along the lines 7-7 of FIG. 5. As illustrated, a cavity 122 is formed within the fitting 100 and includes an inner radius which is substantially the same throughout the length thereof. Since the elbow fitting is coupled to the extending portion 102, the cavity 122 does not include features which are formed to receive other connections.

FIG. 8 illustrates the fitting 100 in a schematic side view to more fully illustrate the configuration of the groove 120. The groove 120 can be substantially arcuate in shape and this shape can be used for the grooves of the fittings 64 and 100. To engage the fitting 100 with the spud 40, the groove 120 includes a directing portion 130 which is positioned adjacent the pins 58 for insertion of the fitting into the spud 40. The directing portion 130 includes a dimension 132 having a width which is larger than the width of the pins 58. As can be seen, the directing portion 130 includes angled side walls 134. As the pin enters the directing portion 130, the angled side walls 134 direct the pins 122 into a receiving portion 136 which is aligned substantially parallel to the axial direction of the flange. As the fitting 100 is moved in a direction 138, the pin moves up into the groove 120 to a location 140. The fitting 100 is then moved in a clockwise direction as viewed from the top of the fitting. Continued clockwise rotation of the fitting 100 moves the pin along the groove 120 in the direction 142 as illustrated until the pin reaches a retaining portion 144 of the groove 120. Once the pin is located within the retaining portion 144, the tool is removed and the spring force moves the fitting 100 in a direction 146 thereby causing the fitting 100 to remain in a locked position. To remove the fitting, the tool is reattached to the apertures 104 and moved in the direction 138. The fitting is moved in a counter-clock-wise direction such that the pin moves opposite the direction 142 wherein it eventually exits at the entry portion 130.

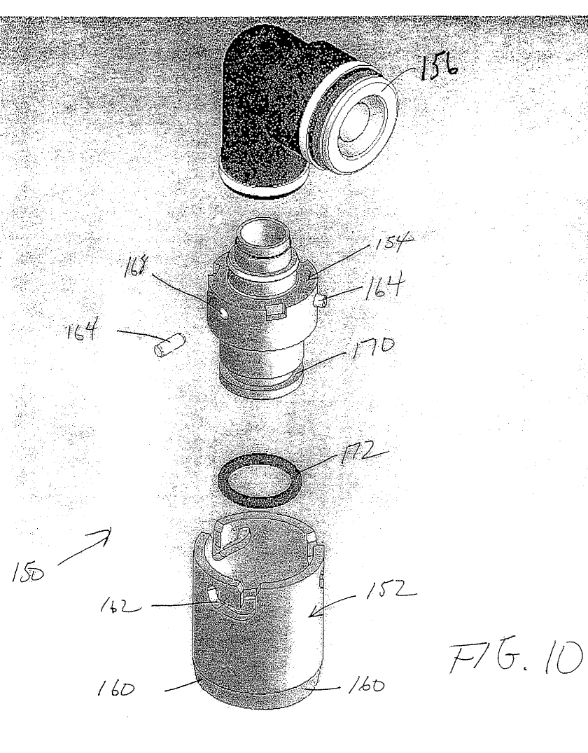

FIG. 9 illustrates another embodiment of a fitting assembly 150 of the present invention. The fitting assembly 150 includes a spud 152 which receives a fitting 154. Attached to the fitting 154 is an elbow 156 as previously described. In the embodiment of FIG. 9, the spud 152 lacks the previously described flange and instead includes a chamfered portion 158 which provides an attachment portion for coupling the spud 152 to a tank or vessel, including the fluid tank 12. The diameter of the chamfer portion 158 decreases as it extends away from a top portion 159 toward a bottom portion 160 of the spud 152. In addition, the spud 152 includes a plurality of grooves, or more particularly, slots 162 formed in the spud 152. The slots 162 are configured substantially the same as the grooves 72 but instead extend completely through the sidewall of the spud 152. In addition, since the fitting 154 now includes a plurality of pins 164 (see FIG. 10) extending from the body of the fitting, the slots 162 are configured such that they are rotated 180 degrees from the previously described configuration. It is within the scope of the present invention to not extend the slots 162 completely through the sidewall of the spud 152. Should grooves otherwise be formed in the interior of the spud 152, indexing grooves can provide for alignment of the spud 152 and fitting 154. Otherwise, the indexing grooves need not be placed on either the spud 152 and fitting 154.

As further illustrated in FIG. 10, the fitting 154 can be seen to include the pins 164 which are inserted into apertures 168. The pins 164 are held in place by either threads, adhesives or other known means. The fitting 154 is otherwise substantially similar to the previously described fitting. For instance, the channel 170 is included to accept an o-ring 172. The spring previously used is not shown, but is still included in the fitting assembly 150.

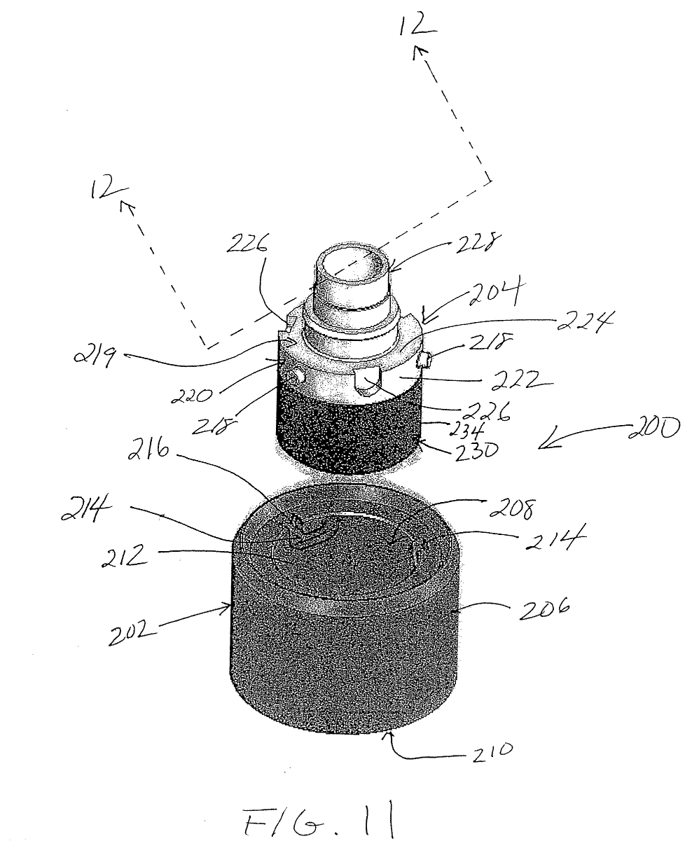

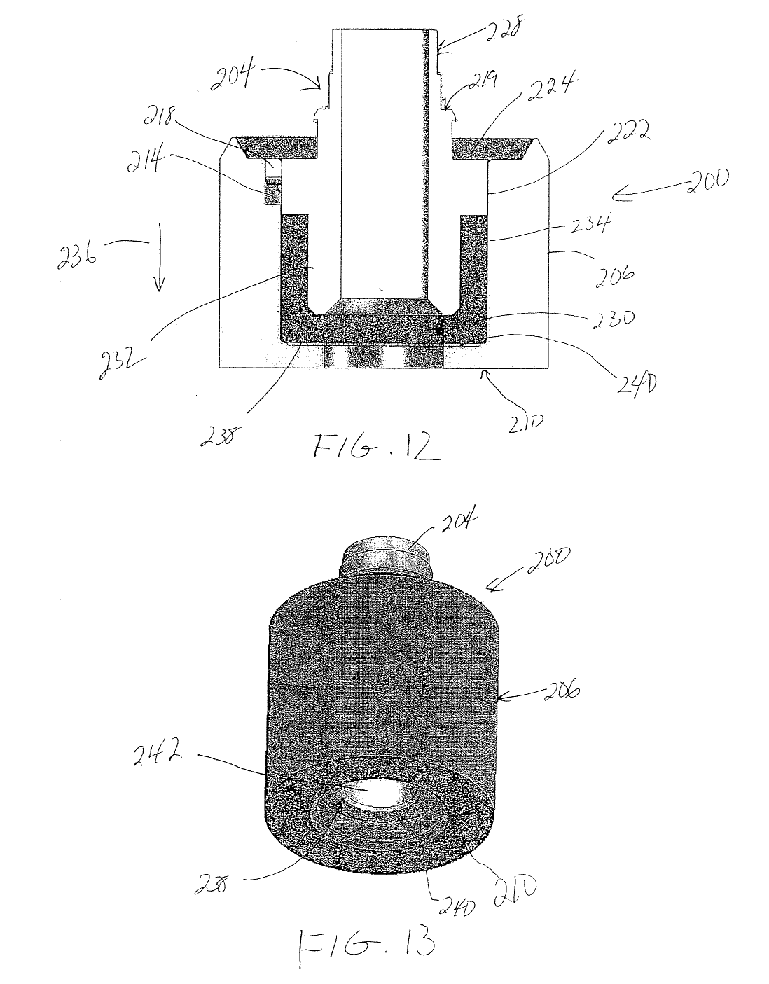

FIG. 11 illustrates another embodiment of a fitting assembly 200 of the present invention. The fitting assembly 200 includes a spud 202 which receives a fitting 204. The spud 202 includes a cylinder 206 which defines a cavity 208 to receive the fitting 204. The cylinder 206 comprises an upstanding sidewall extending from a base portion 210 which is also seen in FIGS. 12 and 13. The cylinder 206 includes an inner wall 212 having defined therein one or more grooves 214. The grooves 214 include a configuration similar to the grooves previously defined with respect to grooves 162 illustrated in FIG. 9. In this case, however, the grooves 214 do note extend completely through the cylinder 206 but instead are formed to extend only through a portion of the sidewall. It is, however, within the scope of the present invention to include grooves 214 which can extend completely through the upstanding sidewall of the cylinder 206.

The groove 214 includes a directing portion 216 which include a dimension sized to receive a corresponding pin or protrusion 218 of the fitting 204. The fitting 204 includes a body 219 which includes a first portion 220 from which the protrusions 218 extend. The protrusions 218 can be formed as integral parts of the first portion 220 or can also include separate pieces which are attached to the first portion 220 through the use of an attachment mechanism such as threaded fittings or adhesives. The first portion 220 of the fitting 204 includes a sidewall 222 which is cylindrical in shape and a top surface 224 which is substantially perpendicular to the sidewall 222. The sidewall 222 and top surface 224 define a plurality of grooves 226 which are adapted to receive a tool (not shown) which can be used to lock and unlock the fitting 204 when it is placed within the cavity 208 of the spud 202. Rotation of the fitting 204 with the tool engages the protrusions 218 with the grooves 214 of the spud 202 such that the fitting 204 can be removably locked or fixed in place when the protrusions 218 engage the grooves 214. An extended portion 228 of the fitting 204 is adapted to receive a coupler as previously described.

The fitting 204 also includes a cap 230 formed of a compressible and/or elastic material. Such materials include natural rubber, synthetic rubber, and elastormeric compounds. The cap 230 is located adjacently to a second portion 232 of the fitting 204, as seen in FIG. 12. The sidewall 222 is substantially planar or contiguous with a sidewall 234 of the cap 230. The outer diameter of the first portion 220 and the outer diameter of the cap 230 are appropriately sized to facilitate insertion of the fitting 204 into the cavity 208. The cap 230, also known as an elastomeric seal provides a spring like force due to the composition of the material used to form the cap. The spring like force enables the fitting 204 to be locked in place when the pins 218 engage the grooves 214 when appropriately positioned. As the fitting 204 is pushed in a direction 236, a bottom portion 238 of the cap is contacted by the base portion 210 of the spud 202 thereby compressing a portion of the cap 230. Compression of the cap 230 not only provides for a compression fit between the fitting 204 and the spud 202 but also provides a fluidic seal between the fitting 204 and the spud 202. Contact of the elastometric seal 230 with an interior surface of the cylinder 206 provides sealing as well as compression fitting.

As illustrated in FIG. 12, the fitting 204 includes the body 219 and the cap 230. The cap 230 can be formed of a preformed and separate cap which fits over the second portion 232 of the fitting 204. An adhesive can be used to hold the cap 230 to the second portion 232. In addition, the cap 232 can be formed through a rubber overmolding process as is known by those skilled in the art. Rubber overmolding provides a mechanism to form a cap adjacent the second portion 232 which can remain in place without the need for an adhesive. In addition, to further maintain the retention of the cap 230 to the second portion 232, the second portion 232 can include a surface having apertures, grooves, indentations, protrusions or other surface structures such that the overmolding is held in place to the second portion 232.

FIG. 13 illustrates a bottom perspective view of the assembly 200 including the cylinder 206 and the fitting 204. The base 210 of the cylinder 206 includes an aperture 238 which terminates at an inside bottom surface 240 of the cylinder 206. The inside bottom surface 240 of the cylinder 206 and the compression seal 230 provide a sealing interface which forms a fluid tight seal therebetween. An aperture 242 of the fitting 204 provides for the transmission of fluid through the fitting as well as through the bottom of the cylinder 206.

It is within the scope of the present invention to include one or more pins cooperating with one or more grooves of either the spud or the fitting. The present invention is therefore not limited to three grooves and three pins. The number of pins and grooves can be selected according to a desired stability and strength of the connection between the spud and the fitting.

In addition, it is also possible to include one or more pins and one or more grooves with the spud or with the fitting. The one or more pins and grooves on a single piece would cooperate with corresponding one or more grooves and pins on the other piece. For instance, should the spud include a groove and a pin, the fitting would include a cooperating pin and groove.

Although the invention has been described in detail with reference to certain illustrated embodiments, variations and modifications exist within the scope and spirit of the present invention as described and defined in the following claims. For instance, it has been shown that the pins of either the spud or the fitting (depending on the location) cooperate with a corresponding groove of the corresponding fitting or spud. Consequently, while the slots or grooves have been shown at the spud of FIG. 10, it is also possible to locate slots or grooves within the spuds of the other embodiments and to locate the pins at the fittings.

1. A fitting assembly for use with a tank containing a fluid, the fitting assembly comprising:
a spud, including spud body having a cavity, the spud body including a protrusion extending into the cavity; and
a fitting, including fitting body having a portion configured to fit within the cavity of the spud body, the fitting including a groove, to receive the protrusion.

2. The fitting assembly of claim 1, wherein the spud body includes an aperture and the protrusion comprises a pin, with the pin being inserted into the aperture.

3. The fitting assembly of claim 1, wherein the spud body includes a flange coupled to the spud body, the flange adapted to be fixed to the tank.

4. The fitting assembly of claim 3, wherein the flange is adapted to be fixed to the tank by welding.

5. The fitting assembly of claim 3, wherein the spud body comprises a cylinder.

6. The fitting assembly of claim 1, wherein the groove of the fitting is substantially arcuate.

7. The fitting assembly of claim 1, wherein the spud body includes an index.

8. The fitting assembly of claim 7, wherein the fitting body includes an index, adapted to indicate proper alignment of the spud body to the fitting body when the protrusion and the groove cooperate to hold the spud body to the fitting body in a fixed position.

9. A fitting assembly for use with a tank containing a fluid, the fitting assembly comprising:
a first body having a cavity, the first body including one of a protrusion and a groove; and
a second body, including a portion configured to fit within the cavity of the first body, the second body including the other of the one of the protrusion and the groove of the first body, wherein the protrusion and the groove cooperate to hold the first body to the second body in a fixed position.

10. The fitting assembly of claim 9, further comprising a flange coupled to the first body, the flange adapted to be fixed to the tank.

11. The fitting assembly of claim 10, wherein the flange is fixed to the tank by welding.

12. The fitting assembly of claim 10, wherein the first body comprises a cylinder.

13. The fitting assembly of claim 9, wherein the groove is substantially arcuate.

14. The fitting assembly of claim 9, wherein the first body includes an index.

15. The fitting assembly of claim 14, wherein the second body includes an index, adapted to indicate proper alignment of the first body to the second body when the protrusion and the groove cooperate to hold the first body to the second body in a fixed position.

16. The fitting assembly of claim 9 wherein the portion comprises a cap to provide a seal between the first body and the second.

17. The fitting assembly of claim 16, wherein the cap comprises an elastomeric cap.

18. A tank system for holding a fluid comprising:
a tank, defining an interior, an exterior, and an aperture; and
a fitting assembly including a spud body coupled to the aperture, the spud body having a cavity and a protrusion extending into the cavity, and a fitting body having a portion configured to fit within the cavity of the spud body, the fitting body including a groove, to receive the protrusion.

19. The tank system of claim 18, wherein the spud body includes an aperture and the protrusion includes a pin, the pin located in the aperture.

20. The tank system of claim 18, wherein the spud body includes a flange coupled to the spud body, the flange being coupled to the interior of the tank.

21. The tank system of claim 20, wherein the flange is fixed to the tank by welding.

22. The tank system of claim 18, wherein the spud body comprises a cylinder.

23. The tank system of claim 18, wherein the groove of the fitting is substantially arcuate.

24. The tank system of claim 18, wherein the spud body includes an index.

25. The tank system of claim 24, wherein the fitting body includes an index, adapted to indicate proper alignment of the spud body to the fitting body when the protrusion and the groove cooperate to hold the spud body to the fitting body in a fixed position.

26. The tank system of claim 25, further comprising a spring, disposed between the spud body and the fitting body, the spring adapted to move the fitting body with respect to the spud body to the fixed position.

27. A pressurizable system for holding a pressurized fluid comprising:
a component, defining an interior, an exterior, and an aperture; and
a fitting assembly including a first body coupled to the aperture, the first body having a cavity and one of a protrusion and a groove, and a second body having a portion configured to fit within the cavity of the first body, the second body including the other of the one of a protrusion and a groove of the first body, wherein the protrusion and the groove cooperate to hold the first body to the second body in a fixed position.

28. The pressurizable system of claim 27, wherein the component comprises a tank.

29. The pressurizable system of claim 27, wherein the component comprises a valve body.

30. The pressurizable system of claim 27, wherein the component comprises a cylinder body.

31. The pressurizable system of claim 27, wherein the component comprises a pneumatic driver.
